(19) United States
(12) Patent Application Publication
(10) Pub. No.: US 2025/0270124 A1
(43) Pub. Date: Aug. 28, 2025

(54) SYSTEM AND PROCESS FOR TURNING WASTE STREAMS INTO ELECTRICAL POWER

(71) Applicant: Steve L Clark, Baytown, TX (US)

(72) Inventor: Steve L Clark, Baytown, TX (US)

(21) Appl. No.: 18/883,023

(22) Filed: Sep. 12, 2024

Related U.S. Application Data
(62) Division of application No. 18/589,830, filed on Feb. 28, 2024.

(51) Int. Cl. C02F 1/58; C02F 1/38; C02F 1/72; C02F 11/06; C02F 101/14; C02F 101/36; C25B 1/04

(52) U.S. Cl. CPC C02F 1/583; C02F 1/38; C02F 1/727; C02F 11/06; C25B 1/04; C02F 2101/14; C02F 2101/36; C02F 2209/02; C02F 2209/03; C02F 2301/046

(57) ABSTRACT

A process for treating waste materials and generating electrical power from simultaneously comprising reacting the waste materials during a reaction with fuel, oxygen and water, and then oxidizing the gaseous reaction product of those materials along with fuel, oxygen and water. In one embodiment the process further comprises the steps of electrolyzing the water exiting the process to produce hydrogen and oxygen, purifying both the hydrogen and oxygen streams, and then feeding the purified hydrogen and oxygen to hydrogen fuel cells to generate power.

### CROSS-REFERENCE TO RELATED APPLICATIONS

This application claims priority to U.S. Utility application Ser. No. 18/589,830 (“the '830 Application”) filed Feb. 28, 2024. The '830 Application is hereby incorporated by reference in its entirety for all purposes, including but not limited to, all portions describing the waste treatment system disclosed, those portions describing waste treatment and power generation in general as background and for use with specific embodiments of the present invention, and those portions describing other aspects of the waste treatment and power generation system that may relate to the present invention.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a per and polyfluoroalkyl substance mitigation. More particularly, the present invention relates to a process for breaking down and destroying PFAS in waste streams. Even more particularly, the present invention relates to breaking down and destroying PFAS in a combustion process designed to have little or no harmful emissions.

### 2. Description of the Related Art

Per- and polyfluoroalkyl substances (PFAS) are a group of manufactured chemicals that have been used in industry and consumer products since the 1940s because of their useful properties. There are thousands of different PFAS, some of which have been more widely used and studied than others. Perfluorooctanoic Acid (PFOA) and Perfluorooctane Sulfonate (PFOS), for example, are two of the most widely used and studied chemicals in the PFAS group. PFOA and PFOS have been replaced in the United States with other PFAS in recent years.

PFAS can be present in our water, soil, air, and food as well as in materials found in our homes or workplaces, including in public drinking water systems and private drinking water wells, at landfills, disposal sites, and hazardous waste sites fire extinguishing foams, manufacturing or chemical production facilities that produce or use PFAS such as chrome plating, electronics, and certain textile and paper manufacturers, fish caught from water contaminated by PFAS and dairy products from livestock exposed to PFAS, food packaging, household products such as stain and water-repellent used on carpets, upholstery, clothing, and other fabrics; cleaning products; non-stick cookware; paints, varnishes, and sealants, certain shampoo, dental floss, and cosmetics, and fertilizer from wastewater treatment plants that is used on agricultural lands.

Current scientific research suggests that exposure to certain PFAS may lead to adverse health outcomes. Research is underway to better understand the health effects associated with low levels of exposure to PFAS over long periods of time, especially in children. Current peer-reviewed scientific studies have shown that exposure to certain levels of PFAS may lead to reproductive effects such as decreased fertility or increased high blood pressure in pregnant women, developmental effects or delays in children, including low birth weight, accelerated puberty, bone variations, or behavioral changes, increased risk of some cancers, including prostate, kidney, and testicular cancers, reduced ability of the body's immune system to fight infections, including reduced vaccine response, interference with the body's natural hormones, and increased cholesterol levels and/or risk of obesity.

In 2021, the United States Environmental Protection Agency (EPA) established the EPA Council on PFAS and charged it with developing an ambitious plan of action to further the science and research, to restrict these dangerous chemicals from getting into the environment, and to immediately move to remediate the problem in communities across the country. This group released the “PFAS Strategic Roadmap: EPA's Commitments to Action 2021-2024” which is hereby incorporated by reference for all purposes including defining the problem, characteristics and sources of PFAS. In the EPA's roadmap, it identifies three technologies that are commercially available to either destroy or dispose of PFAS and PFAS-containing materials but raises concerns about significant uncertainties and information gaps that exist concerning the technologies’ ability to destroy or dispose of PFAS while minimizing the migration of PFAS to the environment.

Inventor Steve Clark's U.S. Pat. No. 5,906,806 entitled “Reduced Emissions Combustion Process with Resource Conservation and Recovery Options ‘ZEROS’ Zero-Emission Energy Recycling Oxidation System” based upon a Oct. 16, 1996, filing introduced a technology for combusting hydrocarbon streams to recover energy and maximize carbon dioxide production and recovery. As the thought leader of combustion and environmental cleanup, Clark continued his research and development to improve the ZEROS technology and to find new uses. Examples of Clark's continued progress in this technology area are found in his other issued patents which include U.S. Pat. No. 6,137,026 entitled “ZEROS Bio-dynamic a Zero Emission Non-Thermal Process for Cleaning Hydrocarbons from Soils”; U.S. Pat. No. 6,024,029 entitled “Reduced Emission Combustion System”; U.S. Pat. No. 6,119,606 entitled “Reduced Emission Combustion Process”; U.S. Pat. No. 6,688,318 entitled “Process for Cleaning Hydrocarbons from Soils”; U.S. Pat. No. 7,338,563 entitled “Process for Cleaning Hydrocarbons from Soil: U.S. Pat. No. 7,833,296 entitled “Reduced-Emission Gasification and Oxidation of Hydrocarbon Materials for Power Generation”; U.S. Pat. No. 8,038,744 entitled “Reduced-emission Gasification and Oxidation of Hydrocarbon Materials for Hydrogen and Oxygen Extraction; and U.S. Pat. No. 8,038,746 entitled “ ” Reduced-emission Gasification and Oxidation of Hydrocarbon Materials for Liquid Fuel Production.” The patents mentioned in this paragraph are hereby incorporated by reference in their entirety for all purposes, including but not limited to those portions describing the method, structure and technical details of the process as background and for use as portions of specific embodiments of the present invention.

As the EPA raised issues with the known process for destroying or disposing of PFAS, it would be desirable to have a process that reliably destroys PFAS from waste materials. It would be even more desirable to adapt a process which has little or no emissions to treat PFAS containing sludges and destroy the PFAS contained therein.

### BRIEF SUMMARY OF THE INVENTION

The present invention is a process for treating PFAS containing waste materials comprising vaporizing the PFAS containing waste materials during a reaction with fuel, oxygen and water, and then oxidizing the gaseous reaction product of those materials along with fuel, oxygen and water to break the fluorine bonds and oxidize the remaining components to carbon dioxide and water. In one embodiment the process for treating PFAS containing waste materials comprises introducing a PFAS containing waste stream, a first oxygen stream, a first fuel stream and a first water stream into a primary combustion chamber operated under vacuum conditions; vaporizing the waste, oxygen, fuel and water streams in the primary combustion chamber to produce gaseous product stream comprising hydrogen, carbon dioxide, PFAS, water vapor and other hydrocarbons and a solids stream; introducing the gaseous product stream into a cyclone separator to separate gaseous components streams from retained particulate components, thereby creating a clean gaseous product stream; introducing the clean gaseous product stream into a secondary combustion chamber along with a second fuel stream, a second oxygen stream, and a second water stream, and thermally oxidizing the introduced components to produce a reaction product stream comprising carbon dioxide and water; recycling a portion of the reaction product stream to the secondary combustion chamber for additional oxidation of any uncombusted reactants; introducing the remaining portion of the reaction product stream into an acid wash scrubber to remove residual fluorine, thereby creating a scrubbed reaction product stream; and separating the scrubbed reaction product stream into a brine stream comprising water and a scrubbed gaseous stream comprising carbon dioxide.

In another embodiment of the process, the process further includes the steps of removing a portion of the water stream from the brine stream creating a regenerated water stream; introducing the regenerated water stream into an electrolysis unit thereby electrolyzing the regenerated water stream to produce a hydrogen and oxygen containing stream; separating the hydrogen from the oxygen in the hydrogen and oxygen containing stream thereby creating a purified hydrogen stream and a purified oxygen stream; and introducing the purified hydrogen stream and the purified oxygen stream into a hydrogen fuel cell to generate electric power.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIG. 1A/B is a process flow diagram of process for breaking down and destroying PFAS; and

FIG. 2 is a process flow diagram of a process for breaking down and destroying PFAS which also generates power through hydrogen fuel cells.

### DETAILED DESCRIPTION OF THE INVENTION

The present invention is a process for treating PFAS containing waste materials comprising vaporizing the PFAS containing waste materials during a reaction with fuel, oxygen and water, and then oxidizing the gaseous reaction product of those materials along with fuel, oxygen and water to break the fluorine bonds and oxidize the remaining components to carbon dioxide and water.

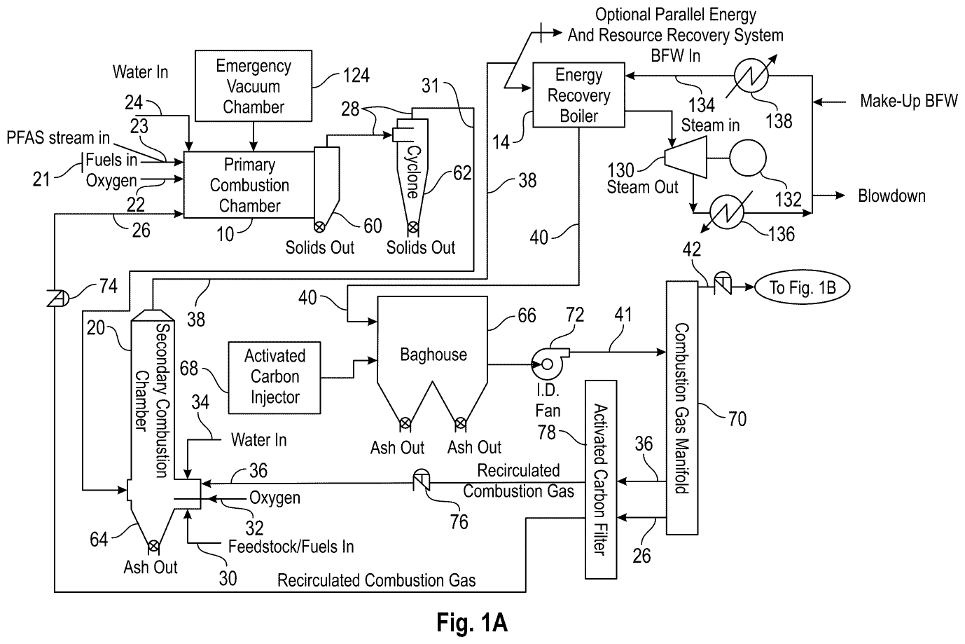

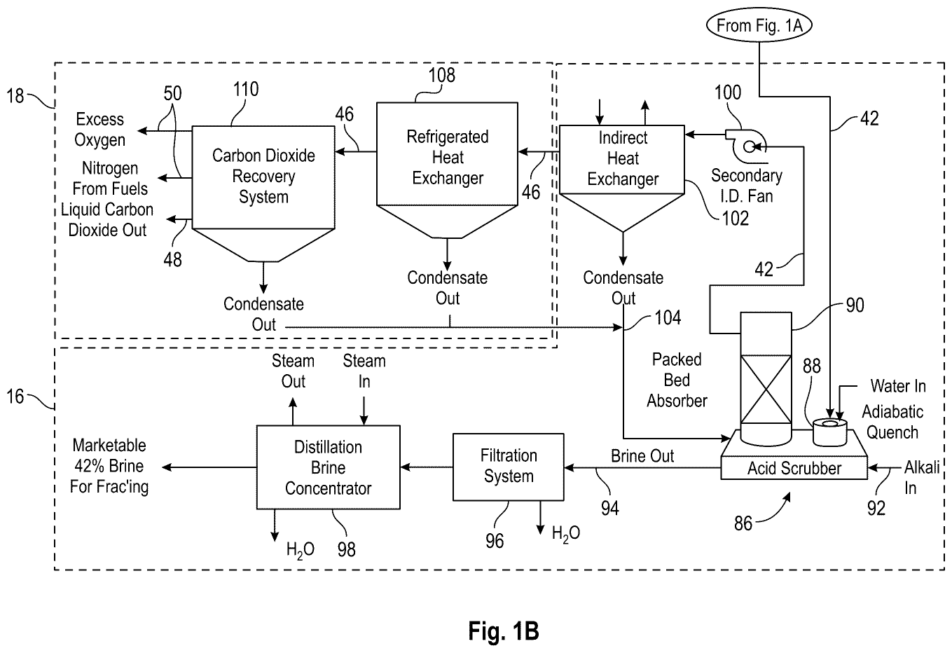

FIGS. 1A and 1B illustrate a preferred implementation of the process and system comprising a primary gasification chamber 10 and a secondary oxidation chamber 20 used to gasify and oxidize, respectively, a PFAS containing waste stream 23 and a hydrocarbon fuel stream 21 to carbon dioxide, water, PFAS free solids and energy. As shown in FIG. 1A, the process of a preferred embodiment of the invention begins by introducing feedstock stream 21, PFAS containing waste stream 23, oxygen stream 22, and water stream 24 into primary combustion chamber 10. Fuel stream 21 can be a variety of hydrocarbon feedstocks, including natural gas, hydrocarbon liquids such as butane, and other hydrocarbon-containing compounds. PFAS containing waste stream 23 can be a variety of sources such as sludges and biosolids from chemical plants, refineries and wastewater treatment facilities. The PFAS containing waste stream 23 can be delivered via vacuum trucks and fed directly to the process or stored in intermediate tanks. In general, the PFAS containing waste stream comprises between about 80% and 99% water. Preferably, waste stream 23 is fed into primary chamber 10 with an auger 25 or other similar type mechanism that allows the stream to be introduced without breaking the vacuum environment. Water containing PFAS can also be injected into the primary chamber 10 (as well as the secondary or cyclone) where the water will be turned to steam and ultimately heated to split the fluorine molecule off. Within primary combustion chamber 10, the hydrocarbon feedstock 21 and hydrocarbons in the PFAS containing waste stream 23 are converted to carbon dioxide, methane, carbon monoxide and hydrogen via the following three principal 55 chemical reactions, listed in order by the preferential affinity of carbon to oxygen in view of all other possible combustion reactions:

Primary Combustion Chamber

| | | |
|---|---|---|
| C + O → | CO2 | Exothermic |
| C + 2H2 → | CH4 | Exothermic |
| C + H2O → | CO + H2 | Endothermic |

The preferred internal operating conditions of the primary combustion chamber 10 comprise a 5% to 10% oxygen rich (i.e., excess oxygen) atmosphere with a preferred temperature of approximately 950 to 1050° F. and an internal pressure of about 8 to 11 psia (i.e., below atmospheric pressure). Preferably primary combustion chamber 10 is a rotary kiln having liquid (preferably water) seals (not shown) on each end to keep the generally liquid PFAS containing waste stream 23 inside the rotating kiln. Water is pumped to the seals to allow water to seep into the primary combustion chamber instead of air. Preferably, primary combustion chamber 10 is a multi-pass system to adequately evaporate the large water volume from the remaining solids. As an additional safety feature to enhance the safety associated with the process, primary combustion chamber 10 is connected to emergency vacuum chamber 124. Primary combustion chamber 10 also has an solids separation section 60 (preferably slag funnels) for removing a portion of solid components including slag, glass and/or ash that results from the gasification process. In general, the solids 61 separated in the solids separation section 60 is about 0.01% of the total feed mass into primary combustion chamber 10. Gasification product 28 is then introduced into a separation cyclone 62 to remove additional ash and solids. In general, about 99.99% of the mass volume introduced into the primary combustion chamber will exit in stream 28 to separation cyclone 62. Preferably stream 28 represents no less than 98% of the combined mass of the PFAS containing waste stream 23, the fuel stream 21, the oxygen stream 22, and the water stream 24. Given the high gas volumes containing some solids generated in primary combustion chamber 10 from PFAS containing waste stream 23, separation cyclone 62 preferably has a different design from prior art systems. Preferably, cyclone 62 comprises a enhanced thickness zone having as much as 10 times the steel thickness as prior art to prevent erosion caused by the large amount of solids in a sandblasting effect. Otherwise, separation cyclone 62 is of a variety commonly known to those skilled in the art of combustion process.

After the solids are removed, gasification product stream 28 is then sent to the secondary combustion chamber 20 via line 31. Preferably, as shown in FIG. 1A, secondary combustion chamber 20 is a vertical combustion chamber such as is known by those of ordinary skill in the art. While the secondary combustion chamber of the prior art was a large energy source, the current process utilizes the secondary combustion system 20 to thermally oxidize PFAS in the gasification product stream 28 and break the fluorine off the hydrocarbon molecule. Gasification product stream 28 containing PFAS and other remaining volatiles are reacted with an additional feedstock stream 30, a second substantially pure oxygen stream 32, and/or a second water stream 34 in secondary combustion chamber 20. Preferably, gasification product stream 28 is preheated in exchanger 63. Feedstock stream 30 can be a variety of hydrocarbon feedstocks, including natural gas, and other high BTU quality wastes. Preferably, secondary combustion chamber 20 operates below atmospheric pressure, most preferably between 10 psia and 12 psia. The preferred internal operating conditions of secondary combustion chamber 20 comprise a 5% oxygen rich atmosphere with a temperature of approximately 2000 to 2,400° F. This condition causes stoichiometric oxidation resulting in a synthetic air environment of carbon dioxide and water without damaging the metal chamber. Preferably, the secondary combustion chamber has about an 8 to 12 second hold time for the combined reacting streams, most preferably about 10 seconds hold time. The formation of carbon dioxide and water (i.e., steam) in the secondary combustion chamber 20 is an auto-thermal driven process that can be summarized by the following three principal chemical reactions, listed in order by the preferential affinity of carbon to oxygen in view of all other possible combustion reactions of the gases produced in the primary combustion chamber 10:

Secondary Combustion Chamber

| | | |
|---|---|---|
| 2CO + O2 → | CO2 | Exothermic Reaction |
| 2H2 + O2 → | 2H2O | Exothermic Reaction |
| CH4 + 2O2 → | CO2 + 2H2O | Exothermic Reaction |

Reaction product stream 38, consisting primarily of carbon dioxide and water, exits from the top of secondary combustion chamber 20. Solids, ash, and other particulate matter are removed from a bottom cone section 64 of secondary combustion chamber 20. Secondary combustion chamber 20 is included in the process to produce high combustion efficiency and break the PFAS fluorine bound from the hydrocarbon.

In preferred embodiments inductor 35 such a large fan system is utilized to induce a circular draft through the secondary combustion chamber 20 with the discharge stream 37 leaving inductor 35 being returned to primary combustion chamber 10 for reprocessing. The inductor 35 allows for gaseous circulation through the system even when the system is not being fired.

An optional feature of the overall process is recovering energy, in the form of heat, from reaction product stream 38 leaving the secondary combustion chamber 20. Preferably, an energy recovery boiler 14 is used to recover the heat energy from reaction product stream 38. As those skilled in the art will recognize, energy recovery boiler 14 is used to generate steam by transferring the heat energy from reaction product 38 to a boiler feedwater stream 134 from boiler feedwater pre-heater 138. A portion of stream 38 can be used in parallel with energy recovery boiler 14 to heat other process streams through heat integration (i.e., cross exchanges of energy). Alternatively, other types of heat exchangers (not shown) can be used to recover the heat energy from reaction product stream 38 in place of energy recovery boiler 14. Removal of the heat energy from stream 38 in recovery boiler 14 results in a cooler stream temperature of approximately 1,200° F. Preferably, stream 38 is cooled to about 450° F.

Cooled reaction product stream 40 is then introduced into a bag house 66 for removal of particulate matter from cooled reaction product stream 40. Bag house 66 is of a design commonly known and used by those skilled in the art. Preferably, an activated carbon injector 68 can be utilized along with bag house 66 to assist in removal of particulate matter. Upon exiting bag house 66, product stream 41 is introduced into combustion gas manifold 70. Fan 72 can be used to increase the pressure of product stream 41 prior to introduction of product stream 41 into gas manifold 70.

In gas manifold 70, product stream 41 is split into three streams. Stream 42, containing the bulk of the flue gas, is routed to gas polishing 16 and purification/recovery 18 units. The remaining two streams 26 and 36 can be recirculated to the primary 10 and secondary 20 combustion chambers, respectively, to maintain the gasification/oxidation environment and increase the combustion efficiency. Stream 26 is recirculated to primary combustion chamber 10 through activated carbon filter 78. Likewise, stream 36 is recirculated to secondary combustion chamber 20 through activated carbon filter 78. The amount of recirculating combustion gas introduced into primary combustion chamber 10 is controlled by control valve 74 or other means of regulating flow volume. Similarly, the amount of recirculating combustion gas introduced into secondary combustion chamber 20 is controlled by control valve 76 or other means of regulating flow volume. Preferably, the temperature of the recirculated flue gas is reduced to approximately 175° F. just prior to the gas being reintroduced into the primary 10 and secondary 20 combustion chambers. To control the system and process, the primary 10 and secondary 20 combustion chambers are monitored for their specific oxygen saturation while flow controllers 74, 76 are used to regulate the recirculation and thereby adjust oxygen levels in order to achieve maximum efficiency. This rigorous control, particularly of oxygen levels, virtually eliminates the production of dioxin within the system. The activated carbon filter 78 within recirculated flue gas streams 26, 36 is a preferred feature of one or more preferred embodiments of the invention. When an additional carbon source is available and the recirculated flue gases in streams 26, 36 are at or above 450° F., carbon dioxide present in the flue gas is converted to carbon monoxide. The carbon monoxide is generated through the Boudouard reaction (C+CO2→2CO) from the additional carbon available in the activated carbon filter 78 and the carbon dioxide present in recirculated flue gas streams 26, 36. The additional carbon monoxide generated increases the overall energy production and efficiency of system/process. Because waste residual heat is used to carry out the endothermic Boudouard reaction, no negative loss in heat gain is experienced in the primary 10 or secondary 20 combustion chambers. The amount of carbon consumed as a filter medium in activated carbon filter 78 is determined by the mass flow rate of recirculated flue gas which is further determined by the total gas flow rate of the system/process. Thus, the carbon within activated carbon filter 78 is a continuous feed system, similar to the reactant in a scrubbing system. While activated carbon filter 78 is shown in FIG. 1A as being a single unit, separate filter units may be employed for each of the streams 26, 36. Alternatively, the activated carbon filter unit 78 may be employed on only one of the streams 26, 36.

Acid gases will not buildup if the temperature is maintained above the acid gas dew point. Thus, the recirculated flue gas temperature is preferably maintained between 450 to 485° F. to eliminate the problem associated with the build up of acid gases. The water in the recirculated gas streams 26, 36 has the effect of moderating the internal temperature as well as providing a mechanism for the removal of sulfurs or metals from the system. The water in the recirculated gas streams 26, 36 also provides a mechanism for the removal of acid buildup, such as hydrochloric acid buildup, formed during the oxidation of halogenated feedstocks.

As previously mentioned, the bulk portion of reaction product stream 41 exits combustion gas manifold 70 as stream 42. Stream 42 comprises carbon dioxide, water, and various other impurities and unreacted components from the combustion process. As illustrated in FIG. 1B, stream 42 is next introduced into acid scrubber system 86 to remove any remaining acidic constituents in the gas stream. Acid scrubber system 86 comprises an adiabatic quench 88 and pack bed absorber 90. Acid scrubber system 86 is of a design commonly known to those skilled in the art of purifying gas streams. Pack bed absorber 90 employs an alkaline stream 92 in a countercurrent flow 30 arrangement to neutralize any acidic components within stream 42. Optionally, acid scrubber system 86 may comprise a series of pack bed absorbers 90 to increase contact efficiency. The brine stream 94, which results from a contact of the alkaline stream 92 with the acid gas components, can then be filtered in filtration system 96. Stream 94 is concentrated in distillation brine concentrator 98 to produce, for example, a marketable 42% brine stream for use in downhole hydrocarbon production, such as fracturing operations.

Upon exiting acid scrubber system 86, the pressure of stream 42 is increased by fan 100 and introduced into indirect heat exchanger 102. Indirect heat exchanger 102 is of a variety commonly known to those skilled in the art of heat transfer. Preferably, ground water at approximately 55° F. is used to condense water vapor from stream 42. The condensation of water vapor also assists in the removal of any remaining contaminates in the gas stream. Additionally, a condensate stream 104 comprising the water and any residual contaminants is returned to acid scrubber system 86 where it is combined with the brine.

Carbon dioxide stream 46 from the indirect heat exchanger 102 is introduced into carbon dioxide recovery unit 18. Initially, stream 46 enters a refrigeration heat exchanger 108. Stream 46 then enters carbon dioxide recovery system 110 where liquid carbon dioxide is separated from any excess oxygen or nitrogen remaining in stream 46. Carbon dioxide recovery system 110 is of a design commonly known to those of ordinary skill in the art. As can be seen, liquid carbon dioxide stream 48 can be marketed as a saleable product. Finally, gas discharge stream 50 comprising excess oxygen and any nitrogen originally introduced through hydrocarbon feedstock streams 21 and 30 can be discharged to the atmosphere. Alternatively, the excess oxygen may be reused within the process as an oxidant or separated for bottling and sale as a product gas. Likewise, the excess nitrogen may be reused within the process as a gaseous fire blanket at the feedstock input or separated for bottling and sale as a product gas. When the process is operated under the conditions described herein, gas discharge stream 50 is eliminated or substantially reduced in comparison to prior art combustion processes.

By utilizing pure oxygen for gasification and oxidation as well as employing water injection and recirculation gas to moderate reaction temperatures, a preferred embodiment of the invention allows virtually all reaction products from the secondary combustion chamber 20 to be reused or marketed. These reaction products include carbon dioxide, water, and excess oxygen. In a preferred embodiment of the invention, provision is made to maintain the highest possible gasification/oxidation efficiency in order to reduce the level of trace organic compounds in the reaction products. Provision is also made to remove, with high efficiency, any acidic and particulate constituents produced by the combustion of less than ideal hydrocarbon feedstocks in the process, thereby allowing the recovery of reusable and marketable reaction products.

As shown in FIG. 1A, the heat energy created and recovered from the system is used in an energy recovery boiler 14, such as a heat recovery steam generator, to generate high and/or low pressure steam. The high and/or low pressure steam from the energy recovery boiler 14 (FIG. 1A) is preferably used in a steam turbine 130 to generate electrical power via generator 132. As shown in FIG. 1A, steam leaving the steam turbine 130 is condensed in condenser 136 and returned as boiler feedwater 134 to the energy recovery boiler 14 via boiler feedwater preheater 138. The generation of steam and power from heat energy is well known in the art and will not be further discussed herein. The overall power production process is much more energy efficient than conventional systerns/processes, because the natural resources consumed in the system/process are minimized, the products produced therefrom are marketable, and virtually no atmospheric or water emissions from the process are released to the environment.

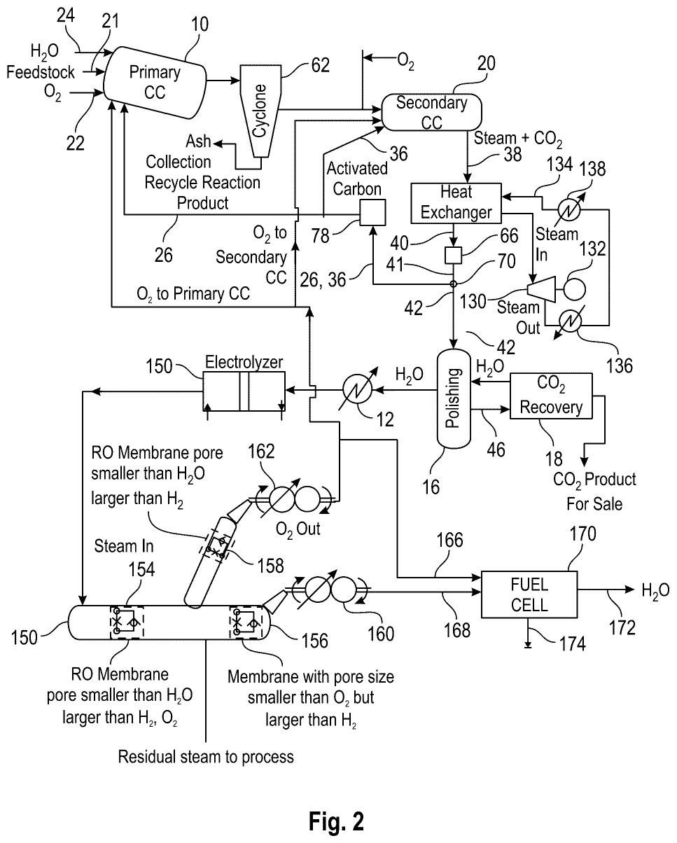

In an alternative preferred embodiment of the invention as shown in FIG. 2, the product water from the process is collected from polishing unit 16. The product water consists of the recovered water quench and/or the water product formed from the complete combustion of various hydrocarbon feedstocks in the primary 10 and secondary 20 chambers (FIG. 1A). Preferably, as shown in FIG. 2, the product water is sent as steam to an electrolyzer or electrolysis unit 150 wherein the water molecules are split into oxygen and hydrogen gases by 35 an electric current. A heat exchanger 12 is optionally used to generate the steam feed to electrolyzer 150. The steam feed preferably has a temperature of about 250° F. and a pressure of about 200 psi. Stream 38 (FIG. 1A) may be used to heat the product water into steam via heat exchanger 12. The electrolyzer or electrolysis unit 150 electrically charges the water vapor, which causes the water molecules to become unstable, break apart, and reform as oxygen and hydrogen gases. In essence, the product water is converted into oxygen and hydrogen gases through the input of additional energy in the form of low cost electricity. The electrolyzer preferably operates with a low voltage of +/−6 volts DC. The mixed oxygen and hydrogen gases and any entrained water vapor are then routed to a separation unit 152 for subsequent separation into their respective pure component gases.

A membrane separation unit 152 is preferred for use in separating the oxygen and hydrogen gases and any entrained water vapor. Membrane separation technology is well known in the art and will only be briefly described herein. Membrane separation technology is based on the differing sizes of gas 55 molecules to be separated. The synthetic membrane of the membrane unit 152 is arranged and designed so that its membrane pores are sized large enough to allow the desired gas molecules to pass through the membrane pores while preventing the passage of undesired gas molecules. Because membrane separation units are passive gas separation systems, the units produce relatively high purity gas separations but at much lower expense than other gas separation technologies. While membrane separation technology is preferred, other gas separation technologies, such as pressure swing adsorption, etc., may be equally employed to remove any entrained water vapor as well as separate the oxygen and hydrogen gases generated in the electrolysis unit 150.

As shown in FIG. 2, the membrane separation unit 152 preferably comprises at least three separate membranes 154, 156, 158. The first membrane 154 of the membrane separation unit 152 is arranged and designed with membrane pores sized to allow the smaller hydrogen and oxygen gas molecules to pass therethrough while retaining, and thus separating, any entrained larger water vapor molecules. The recovered water vapor is collected and routed back to the process for subsequent reuse. The second membrane 156 of the membrane separation unit 152 is arranged and designed with membrane pores sized to allow hydrogen gas molecules to pass therethrough while retaining, and thus separating, the larger oxygen gas molecules.

The operating temperature (i.e., preferably above the dew 25 point of water) and pressure (i.e., preferably above atmospheric) of the three membranes 154, 156, 158 are optimized to achieve the desired degree of separation. Likewise, a vacuum (not shown) may be drawn on the backside of the membranes 154, 156, 158 in order to enhance the recovery of 30 desired molecules through the membranes 154, 156, 158. While three separate membranes 154, 156, 158 are described herein, the invention is not limited to any particular number or arrangement of membranes. As is well known in the art, two or more membranes may be arranged in a series and/or parallel structure to produce the desired component separation and/or purification standards.

After an optional polishing and/or compression step 160, the purified hydrogen gas 168 can bottled or otherwise sold as value added product. The recovered oxygen gas is further purified by sending the gas through third membrane 158 which prevents the passage of any additional water vapor that may be present as a result of water reformation. The recovered water vapor is collected and routed back to the process for subsequent reuse. After an optional polishing and/or compression step 162, the purified oxygen gas 166 can be bottled or otherwise sold as value added product or routed back to the process as a feedstock in the primary 10 and/or secondary 20 combustion chambers.

In another embodiment of the system as shown in FIG. 2, purified hydrogen gas 168 and the purified oxygen gas 166 generated a combustion process such as disclosed herein or in the inventor's prior art patents (also known as ZEROS plants) can be utilized in hydrogen fuel cells 170 to generate electric power 174. Reacting a fuel, such as hydrogen, and oxygen electrochemically involves delivering fuel to a set of negative electrodes called anodes and delivering oxygen to a set of positive electrodes called cathodes inside the fuel cell 170. As will be now be recognized by those of skill in the art, typical commercial carbonate fuel cells would be modified for this application. These prior art carbonate fuel cells are typically designed for methane (CH4) as the fuel and therefore generate carbon dioxide (CO2). As can now be seen, the inlet and outlets of the fuel cells 170 will be modified to input hydrogen stream 168 and output water stream 172. Additionally, as discussed below, the anodes and cathodes will preferably be modified from the prior art.

The electrochemical reaction of hydrogen inside fuel cell 170 produces electrons. The electrochemical reaction of oxygen consumes electrons. Connecting the two produces a current of usable electric power 174. Fuel cells 170 generally contain a layer between the electrodes called an electrolyte layer. The electrolyte has ions that move between the fuel and oxygen electrodes to keep the charge neutral between the electrodes as they produce and consume electrons. The electrolyte is preferably made from potassium and lithium carbonates and carbonate ions migrate between the fuel and oxygen.

Fuel cells 170 preferably are configured in stacks of individual cells connected in series. Fuel cell stacks preferably have up to 400 cells per stack and produce between 250 kW and 400 kW of electric power 174. Fuel cells 170 preferably operate at a relatively high temperature (400 to 1,000 degrees F.). Operating at higher temperature allows the electrode reaction to produce power efficiently without expensive platinum type catalyst. It is also a high enough temperature that allows the hydrogen in the fuel stack to generate electricity. In addition to allowing hydrogen and oxygen in the fuel cell to react the high temperature of the process allows the fuel cell to reach a 60% efficiency and considering the combined heat and power (CHP) the produced energy efficiency can reach 90% or higher.

A fuel cell 170 of standard MW (megawatt) scale module contains four stacks nets around 1.4 MW of electric power 174 and can power sites like universities and hospitals as well as industrial sites and chemical plants. The modular design of fuel cell plants 170 let them scale up to a site's energy needs. When paired with a ZEROS plant the standard fuel cell size can deliver 59 MW's of electric power that is carbon free, is base load, and emits only a water stream 172. This can be achieved in a ZEROS plant from the disposal of the municipal solid waste produced by the facility or could be fueled by plastic production waste or refinery waste from industry. This embodiment of a ZEROS plant combined with utilization of the hydrogen gas stream 168 and the oxygen steam 166 creates a waste to energy facility would solve several industry problems while producing base load energy with total carbon capture. This combustion free process emits only water, no pollutants, supporting the goal of no carbon emissions in generating power.

While the terms used herein are believed to be well-understood by one of ordinary skill in the art, definitions are set forth to facilitate explanation of certain of the presently-disclosed subject matter.

Following long-standing patent law convention, the terms “a”, “an”, and “the” refer to one or more when used in this application, including the claims. Thus, for example, reference to “a window” includes a plurality of such windows, and so forth.

Unless otherwise indicated, all numbers expressing quantities of elements, dimensions such as width and area, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of appears in a clause of the body of a claim, rather than immediately following the preamble, it limits only the element set forth in that clause; other elements are not excluded from the claim as a whole.

As used herein, the phrase “consisting essentially of limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and subcombinations of A, S, C, and O.

The Abstract of the disclosure is written solely for providing the United States Patent and Trademark Office and the public at large with a means by which to determine quickly from a cursory inspection the nature and gist of the technical disclosure, and it represents one preferred implementation of the invention and is not indicative of the nature of the invention as a whole.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. A process for treating waste materials to generate electric power comprising:
introducing a waste stream, a first oxygen stream, a first fuel stream and a first water stream into a primary combustion chamber operated under vacuum conditions;
reacting the waste, oxygen, fuel and water streams in the primary combustion chamber to produce a gaseous product stream comprising hydrogen, carbon dioxide, water vapor and other hydrocarbons and a solids stream;
introducing the gaseous product stream into a cyclone separator to separate gaseous components of the gaseous product stream from any retained particulate components of the gaseous product stream, thereby creating a clean gaseous product stream;
introducing the clean gaseous product stream into a secondary combustion chamber along with a second fuel stream, a second oxygen stream, and a second water stream, and thermally oxidizing the introduced streams to produce a reaction product stream comprising carbon dioxide and water;
recycling a portion of the reaction product stream to the secondary combustion chamber for additional oxidation of any uncombusted reactants;
introducing the remaining portion of the reaction product stream into an acid wash scrubber to remove residual fluorine, thereby creating a scrubbed reaction product stream; and
separating the scrubbed reaction product stream into a brine stream comprising water and a scrubbed gaseous stream comprising carbon dioxide;
removing a portion of the water from the brine stream creating a regenerated water stream;
introducing the regenerated water stream into an electrolysis unit thereby electrolyzing the regenerated water stream to produce a hydrogen and oxygen containing stream;
separating the hydrogen from the oxygen in the hydrogen and oxygen containing stream thereby creating a purified hydrogen stream and a purified oxygen stream; and
introducing the purified hydrogen stream and the purified oxygen stream into a hydrogen fuel cell to generate electric power.

2. The process of claim 1 wherein said hydrogen fuel cell comprises a plurality of fuel cell stacks, each hydrogen fuel cell stack comprising a plurality of individual cells connected in series, each individual cell comprising an anode, an electrolyte, a cathode, a hydrogen inlet, an oxygen inlet, and a water outlet.

3. The process of claim 2 wherein said hydrogen fuel cell operates at between about 400 and about 1000° F.

4. The process of claim 2 wherein said hydrogen fuel cell operates at least 60% efficiency.

5. The process of claim 2 wherein the hydrogen fuel cell comprises four fuel cell stacks.

6. The process of claim 2 wherein the hydrogen fuel cell produces between 250 and 400 kW of electric power.

7. The process of claim 1 wherein the separating the hydrogen and oxygen step comprise introducing the hydrogen and oxygen containing stream into a membrane separation unit comprising a first membrane for separating water from the hydrogen and oxygen in the hydrogen and oxygen containing stream, and a second membrane for separating hydrogen from oxygen.

8. The process of claim 2 wherein the electrolyte comprises potassium carbonate.

9. The process of claim 2 wherein the electrolyte comprises lithium carbonate.

10. The process of claim 2 wherein the hydrogen fuel cell comprises four hydrogen fuel cell stacks and produces about 1.4 megawatts of electric power.

11. The process of claim 1 wherein the waste stream comprises municipal solid waste.

12. The process of claim 1 wherein the waste stream is a liquid stream comprising sludge from refinery or chemical plants.

13. A process for treating waste materials to generate electric power comprising:
introducing a waste stream, a first oxygen stream, a first fuel stream and a first water stream into a primary combustion chamber operated under vacuum conditions;
reacting the waste, oxygen, fuel and water streams in the primary combustion chamber to produce a gaseous product stream comprising hydrogen, carbon dioxide, water vapor and other hydrocarbons and a solids stream;
introducing the gaseous product stream into a cyclone separator to separate gaseous components of the gaseous product stream from any retained particulate components of the gaseous product stream, thereby creating a clean gaseous product stream;
introducing the clean gaseous product stream into a secondary combustion chamber along with a second fuel stream, a second oxygen stream, and a second water stream, and thermally oxidizing the introduced streams to produce a reaction product stream comprising carbon dioxide and water;
recycling a portion of the reaction product stream to the secondary combustion chamber for additional oxidation of any uncombusted reactants;
introducing the remaining portion of the reaction product stream into an acid wash scrubber to remove residual fluorine, thereby creating a scrubbed reaction product stream; and
separating the scrubbed reaction product stream into a brine stream comprising water and a scrubbed gaseous stream comprising carbon dioxide;
removing a portion of the water from the brine stream creating a regenerated water stream;
introducing the regenerated water stream into an electrolysis unit thereby electrolyzing the regenerated water stream to produce a hydrogen and oxygen containing stream;
separating the hydrogen from the oxygen in the hydrogen and oxygen containing stream thereby creating a purified hydrogen stream and a purified oxygen stream; and
introducing the purified hydrogen stream and the purified oxygen stream into a hydrogen fuel cell to generate electric power, wherein the hydrogen fuel cell comprises a plurality of fuel cell stacks, each fuel cell stack comprising a plurality of individual cells connected in series, each individual cell comprising an anode, an electrolyte, a cathode, a hydrogen inlet, an oxygen inlet, and a water outlet, and wherein the hydrogen fuel cell operates at between about 400 and 1000° F.

14. The process of claim 2 wherein said hydrogen fuel cell operates at least 60% efficiency.

15. The process of claim 2 wherein the hydrogen fuel cell comprises four fuel cell stacks.

16. The process of claim 2 wherein the hydrogen fuel cell produces between 250 and 400 kW of electric power.

17. The process of claim 1 wherein the separating the hydrogen and oxygen step comprise introducing the hydrogen and oxygen containing stream into a membrane separation unit comprising a first membrane for separating water from the hydrogen and oxygen in the hydrogen and oxygen containing stream, and a second membrane for separating hydrogen from oxygen.

18. The process of claim 2 wherein the electrolyte comprises potassium carbonate.

19. The process of claim 2 wherein the electrolyte comprises lithium carbonate.

20. The process of claim 2 wherein the hydrogen fuel cell comprises four hydrogen fuel cell stacks and produces about 1.4 megawatts of electric power.
